(19) United States
(12) Patent Application Publication
(10) Pub. No.: US 2003/0171900 A1
(43) Pub. Date: Sep. 11, 2003

(54) Non-Gaussian detection

(75) Inventor: Mukund N. Desai, Needham, MA (US)

Correspondence Address: TESTA, HURWITZ & THIBEAULT, LLP, HIGH STREET TOWER, 125 HIGH STREET, BOSTON, MA, 02110, US

(73) Assignee: The Charles Stark Draper Laboratory, Inc., Cambridge, MA

(21) Appl. No.: 10/385,478

(22) Filed: Mar. 11, 2003

Related U.S. Application Data
(60) Provisional application No. 60/363,500, filed on Mar. 11, 2002.

(51) Int. Cl. G06F 15/00

(52) U.S. Cl. 702/190

(57) ABSTRACT

A system and method for detection of a particular signal of interest within a set of measurements. The particular signal of interest is detected in the presence of arbitrary noise and interferents. The system and method are capable of detecting the presence of the particular signal of interest in the presence of non-Gaussian noise and unknown interference. The system and method also are capable of detecting the presence of the particular signal of interest in the presence of interferents that lie in a different subspace from the signal of interest, but nevertheless corrupt the measurements.

### REFERENCE TO RELATED APPLICATIONS

This application claims the benefit of U.S. Provisional Patent Application Serial No. 60/363,500, filed on Mar. 11, 2002, and entitled “Non-Gaussian Detection,” the entire contents of which are incorporated by reference herein.

### GOVERNMENT SUPPORT

This invention was made with government support under Contract Number NINDS-1R01-NS34189, awarded by Public Health Services/National Institute of Health (PHS/NIH). The Government may have certain rights in the invention.

### FIELD OF THE INVENTION

The invention generally relates to the field of signal detection. In particular, in one embodiment, the invention relates to detectors for signal detection in the presence of arbitrary noise and interferents of uncertain characteristics.

### BACKGROUND OF THE INVENTION

Signal detection involves establishing decision-making rules or tests to be implemented on a set of measurement data for the purpose of determining whether a particular signal of interest is present within a set of measurement data. Signal detection is typically performed with the aid of a computer that is well suited to implement such rules or tests as a set of mathematical calculations. Detecting the presence of a particular signal of interest within a set of measurement data is often complicated by the presence of noise or some other interferent signal within the measurement data. The noise or interferent may act to mask the presence of the signal of interest.

Signal detection methods exist that account for, for example, the presence of noise that can be approximated as a Gaussian probability density function. However, prior art systems do not effectively detect the presence of a particular signal of interest in the presence of noise that cannot be accurately approximated as a Gaussian probability density function, nor do prior art systems effectively detect the presence of a particular signal of interest in the presence of interferents of uncertain or unknown characteristics.

### SUMMARY OF THE INVENTION

The invention, overcomes the deficiencies of the prior art by, in one aspect, providing a method for determining the presence of a signal of interest within a set of measurement data, the method including the steps of extracting data representative of a first signal having characteristics associated with the signal of interest from the measurement data; extracting data representative of one or more second signals having characteristics dissimilar to the signal of interest; and processing the data representative of the first signal with the data representative of the one or more second signals to determine the likelihood of the signal of interest being present in the measurement data.

According to one embodiment, the method includes filtering the measurement data to remove a known interferent signal from the measurement data. According to a further embodiment, the method includes determining a probability of whether the signal of interest is present within the set of measurement data. According to one feature, the one or more second signals include a noise signal. According to another feature, the noise signal can be described by a non-Gaussian (e.g., generalized Gaussian or Laplacian) probability density function.

In some embodiments, the measurement data includes a known interferent signal. According to further embodiments, the method includes determining whether the signal of interest is present or absent within the measurement data. According to one feature of this embodiment, the method includes calculating a ratio of at least two residual values, the ratio representing a likelihood that the signal of interest is present within the measurement data. According to another feature, the method includes determining the presence of a signal of interest within a set of new measurement data, the method including the steps of extracting data representative of a first signal having characteristics associated with the signal of interest from the measurement data; extracting data representative of one or more second signals having characteristics dissimilar to the signal of interest; and processing the data representative of the first signal with the data representative of the one or more second signals to determine the likelihood of the signal of interest being present in the measurement data.

In general, in another aspect, the invention is directed to a system for determining the presence of a signal of interest within a set of measurement data. According to one embodiment, the system includes a processor for extracting data representative of a first signal that has characteristics associated with the signal of interest. According to a further embodiment, the processor also extracts data representative of one or more second signals that have characteristics dissimilar to the signal of interest. According to another embodiment, the processor processes the data representative of the first signal with the data representative of the one or more second signals to determine the likelihood of whether the signal of interest is present or absent in the measurement data.

In some embodiments, the system includes a sensor for acquiring the measurement data. In another embodiment, the system includes a receiver for receiving the measurement data from the sensor. In some embodiments, the system includes a filter for filtering the measurement data to remove a known interferent signal from the measurement data. In other embodiments the processor determines whether the signal of interest is present or absent within the set of measurement data.

In some embodiments, the one or more second signals include a noise signal and/or unknown interferents. In other embodiments, the noise signal can be described by a non-Gaussian (e.g., generalized Gaussian or Laplacian) probability density function.

In general, in another aspect, the invention is directed to a detector for determining the presence of a signal of interest within a set of measurement data, wherein the detector includes a likelihood ratio having the formula:

$$λ ( x ) = \frac{{x}^{′} ( {P}_{S} - {P}_{U} ) x}{2 {σ}^{2}} ;$$

where x is a vector of measurement data, x′ is the transpose of x, S is a matrix whose columns span the signal space, Pₛ is the projection operator that projects a vector along signal space, U is the matrix whose columns span the unknown interferent space, Pᵤ is the projection operator that projects a vector along unknown interferent space and σ is the standard deviation of noise.

In general, in another aspect, the invention is directed to a detector for determining the presence of a signal of interest within a set of measurement data, wherein the detector includes a likelihood ratio having the formula:

$$λ ( x ) = \frac{\vert {s}^{′} x \vert}{{‖ s ‖}_{q} {‖ x - s {\hat{θ}}_{p} ‖}_{p}} ;$$

where x is a vector of measurement data, \hat{θ}ₚ is the maximum likelihood estimate of θ, s is a vector that spans the signal space, θ is the gain vector associated with s, p is the shape parameter of the probability density function of noise and q is equal to

$$\frac{p}{p - 1} .$$

In general, in another aspect, the invention relates to a detector for determining the presence of a signal of interest within a set of measurement data. The detector includes a likelihood ratio having the formula:

$$Λ ( x ) = \frac{{‖ x - U {\hat{ψ}}_{p} ‖}_{p}}{{‖ x - S {\hat{θ}}_{p} ‖}_{p}} ;$$

where x is a vector of measurement data, \hat{θ}ₚ is the maximum likelihood estimate of θ, S is a matrix whose columns span the signal space, θ is the gain vector associated with S, U is the matrix whose columns span the interferent space, \hat{ψ}ₚ is the maximum likelihood estimate of ψ, ψ is the gain vector associated with U, and p is the shape parameter of the probability density function of noise.

In general, in another aspect, the invention relates to a detector for determining the presence of a signal of interest within a set of measurement data. The detector includes a likelihood ratio having the formula:

$$λ ( x ) = - {( \frac{1}{{ω}_{1}} {‖ x - s {\hat{θ}}_{p} ‖}_{p} )}^{p} + {( \frac{\vert {s}^{′} x \vert}{{‖ {ω}_{0} s ‖}_{q}} )}^{p}$$

where x is a vector of measurement data, \hat{θ}ₚ is the maximum likelihood estimate of θ, s is a vector that spans the signal space, θ is the gain vector associated with s, ω₀ is a width factor associated with known noise, ω₁ is a width factor associated with unknown noise, p is the shape parameter of the probability density function of noise, and q is equal to

$$\frac{p}{p - 1} .$$

In general, in another aspect, the invention relates to a detector for determining the presence of a signal of interest within a set of measurement data. The detector includes a likelihood ratio having the formula:

$$Λ ( x ) = - {( \frac{1}{{ω}_{1}} {‖ x - S {\hat{θ}}_{p} ‖}_{p} )}^{p} + {( \frac{1}{{ω}_{0}} {‖ x - U {\hat{ψ}}_{p} ‖}_{p} )}^{p}$$

where x is a vector of measurement data, \hat{θ}ₚ is the maximum likelihood estimate of θ, S is a matrix whose columns span the signal space, θ is the gain vector associated with S, U is the matrix whose columns span the interferent space, \hat{ψ}ₚ is the maximum likelihood estimate of ψ, ψ is the gain vector associated with U, ω₀ is a width factor associated with known noise, ω₁ is a width factor associated with unknown noise, and p is the shape parameter of the probability density function of noise.

In general, in another aspect, the invention relates to a detector for determining the presence of a signal of interest within a set of measurement data. The detector includes a likelihood ratio having the formula:

$$Λ ( x ) = \frac{{‖ x ‖}_{p}}{{‖ x - S {\hat{θ}}_{p} ‖}_{p}}$$

where x is a vector of measurement data, \hat{θ}ₚ is the maximum likelihood estimate of θ, S is a matrix whose columns span the signal space, θ is the gain vector associated with S, and p is the shape parameter of the probability density function of noise. According to a further embodiment, the matrix S spans a one-dimensional signal space.

In general, in another aspect, the invention relates to a detector for determining the presence of a signal of interest within a set of measurement data. The detector includes a likelihood ratio having the formula:

$$Λ ( x ) = - {( \frac{1}{{ω}_{1}} {‖ x - S {\hat{θ}}_{p} ‖}_{p} )}^{p} + {( \frac{1}{{ω}_{0}} {‖ x ‖}_{p} )}^{p}$$

where x is a vector of measurement data, \hat{θ}ₚ is the maximum likelihood estimate of θ, S is a matrix whose columns span the signal space, θ is the gain vector associated with S, ω₀ is a width factor associated with known noise, ω₁ is a width factor associated with unknown noise, and p is the shape parameter of the probability density function of noise. According to a further embodiment, the matrix S spans a one-dimensional signal space.

The foregoing and other objects, aspects, features, and advantages of the invention will become more apparent from the following description and from the claims.

### BRIEF DESCRIPTION OF THE DRAWINGS

The foregoing and other objects, feature and advantages of the invention, as well as the invention itself, will be more fully understood from the following illustrative description, when read together with the accompanying drawings which are not necessarily to scale.

FIG. 1 is a graph depicting a method for detecting the presence of a signal of interest within a measurement signal, according to an illustrative embodiment of the invention.

FIG. 2 is a graph depicting an improvement in the method of FIG. 1 for detecting the presence of a signal of interest within a measurement signal in the presence of an interferent, according to an illustrative embodiment of the invention.

FIG. 3 is a graph depicting the performance of an optimal detector Λ_{2,pk} for detecting the presence of a signal of interest within a set of measurement data, according to an illustrative embodiment of the invention.

FIG. 4 is a graph depicting the performance of two CFAR detectors Λ_{2,ou} and Λ_{2,ru} for detecting the presence of a signal of interest within a set of measurement data, according to an illustrative embodiment of the invention.

FIG. 5 is a graph depicting the performance of a robust detector Λ_{2,rk}>0 for detecting the presence of a signal of interest within a set of measurement data, according to an illustrative embodiment of the invention.

FIG. 6 is a graph depicting the performance of a robust detector Λ_{2,rk}<0 for detecting the presence of a signal of interest within a set of measurement data, according to an illustrative embodiment of the invention.

FIG. 7 is a graph depicting the probability of a detector correctly detecting the presence of a signal of interest within a set of measurement data versus the probability of the detector falsely detecting the presence of a signal of interest for various illustrative detectors of the invention.

FIG. 8 is a graph depicting the probability of a detector correctly detecting the presence of a signal of interest within a set of measurement data versus the probability of the detector falsely detecting the presence of a signal of interest in which the measurement data contains Laplacian noise, for two different illustrative detectors of the invention.

FIG. 9 is a flow chart depicting a computer implementation of an illustrative embodiment of the method according to the invention.

FIG. 10 is a block diagram of a system for detecting the presence of a signal of interest within a set of measurement data, according to an illustrative embodiment of the invention.

### DETAILED DESCRIPTION OF ILLUSTRATIVE EMBODIMENTS

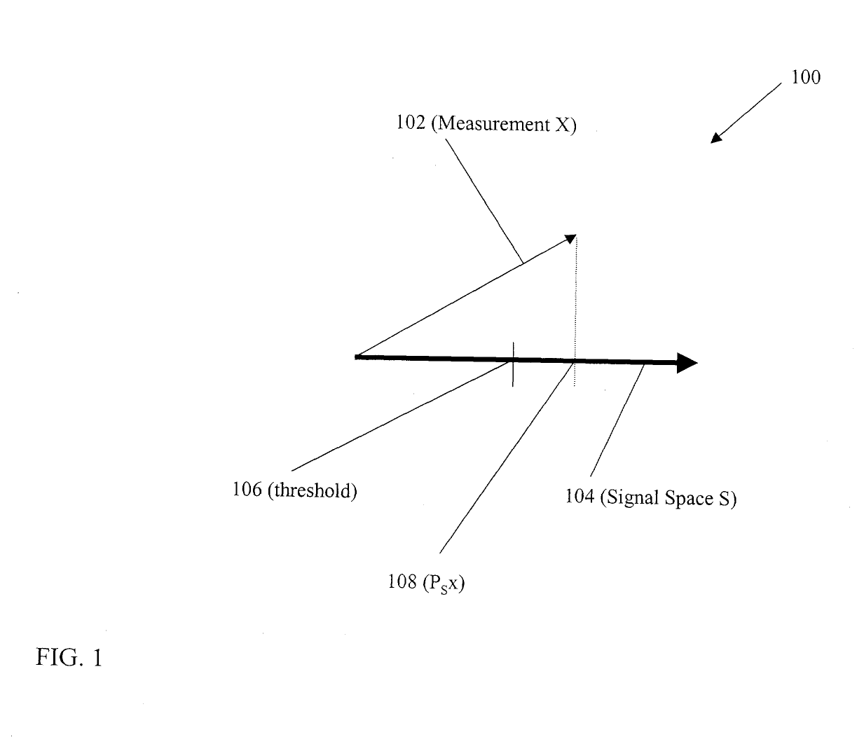

FIG. 1 is a graph 100 depicting a method for detecting the presence of a particular signal of interest within a set of measurement data, according to an illustrative embodiment of the invention. The method for detecting can be implemented, for example, with a computer processor or detector. This aspect of the invention involves determining a magnitude 108 of a vector (Pₛx) that is the projection of a Measurement X 102 onto a Signal Space S 104. A signal (projection of a set of measurement data) that lies along the direction of the Signal Space S 104 is indicative of the presence of the particular signal of interest within the set of measurement data. The method of FIG. 1 indicates the presence of a particular signal of interest within the set of measurement data (Measurement X 102) if the magnitude 108 is larger than a threshold value 106. Alternatively, if the magnitude 108 is less than the threshold value 106 the method of FIG. 1 indicates the absence of the particular signal of interest within the measurement data (Measurement X 102).

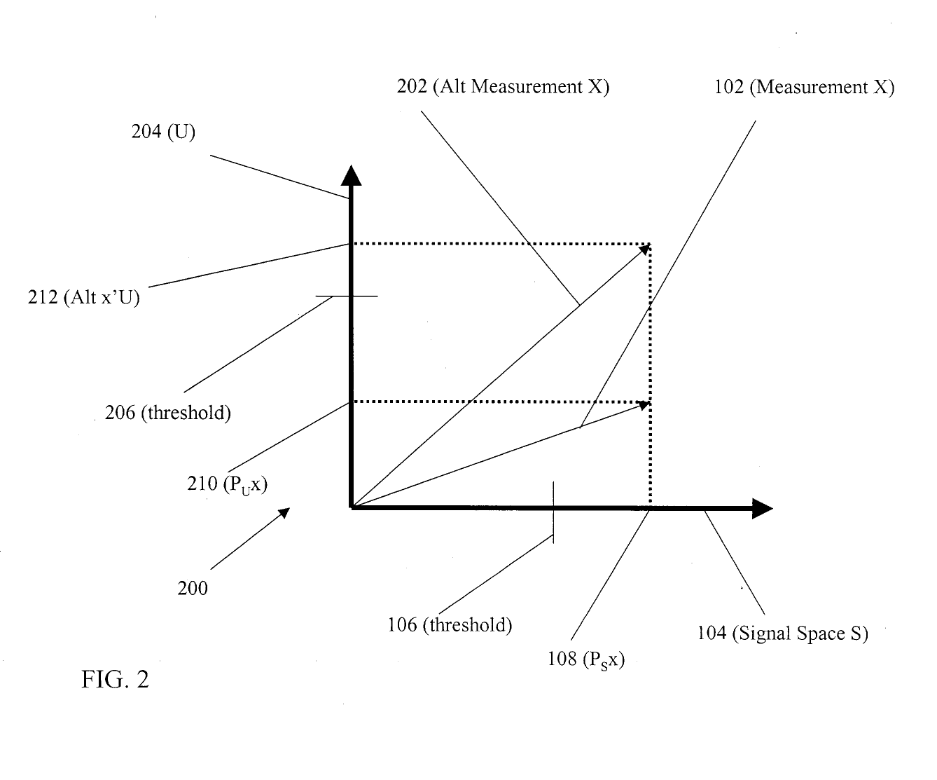

FIG. 2 is a graph 200 depicting a method of determining the presence of a signal of interest within a set of measurement data, according to a further illustrative embodiment of the invention. The method of FIG. 2 improves over the method of FIG. 1 by also taking into account the projection 210 (magnitude of P_{U}x) of the measurement data 102 (Measurement X) along a direction U 204. The direction U 204 represents the Null Space of S which is orthogonal to Signal Space S 104. The portion of the measurement data or components of the measurement data that lie along the direction U 204 indicate an absence of the signal of interest. Components of measurement data that lie along the direction U 204 can be attributed, for example, to the existence of interferents (e.g., a jamming signal in a radar detection application) or noise (e.g., electrical noise in a sensor). When the projection 210 (magnitude of P_{U}x) is large relative to, for example, a predetermine threshold 206, it may be desirable for a detector to indicate the absence of the signal of interest.

As shown in FIG. 2, this method of detecting indicates the absence of the signal of interest within a set of measurement data 202 (Alt Measurement X) if the projection 212 (magnitude of Alt P_{U}x) of the projection of Alt Measurement X 202 along the direction of U 204 is greater than a threshold 206. Alternatively, if the magnitude of P_{U}x 210, the projection of Measurement X 102 along the direction U 204, is less than the threshold 206, this method indicates the presence of the signal of interest.

According to an alternative illustrative embodiment, the method of the invention takes into account both the magnitude of the projection of the measurement data along the direction U 204, as well as a magnitude of the projection of the measurement data along the Signal Space S 104 to determine the presence or absence of a signal of interest within the set of measurement data. The method of the invention, for example, may determine the presence or absence of the signal of interest within the measurement data by comparing to a predetermined value a ratio of the magnitude of the projection of the measurement data along the Signal Space S 104 to the magnitude of the projection of the measurement data along the Interferent Space U 204

$$( \frac{\vert {P}_{S} x \vert}{\vert {P}_{U} x \vert} ) .$$

According to a further illustrative embodiment, the method of the invention employs hypothesis testing on the measurement data to determine whether a signal of interest is present in the measurement data. Hypothesis testing is a method of inferential statistics. An operator, for example, assumes what the characteristics (e.g., mathematical description) are of a signal of interest, called the signal space (H₁) hypothesis. Measurement data are then collected and the viability of the H₁ hypothesis is determined in light of the data. If the data are very similar to what would be expected under the H₁ hypothesis, then the hypothesis test indicates the presence of the signal of interest within the measurement data.

Hypothesis testing as applied to signal detection involves employing an H₁ hypothesis test (assuming the presence of the signal of interest) as well as an H₀ hypothesis test (assuming the absence of a signal of interest). The H₁ test and the H₀ test are used, for example, to determine a likelihood that the signal of interest is present in measurement data versus the likelihood that the signal of interest is absent from the measurement data. The likelihood is used to estimate a receiver operating characteristic (ROC) performance that is used to compare the performance of different signal detectors.

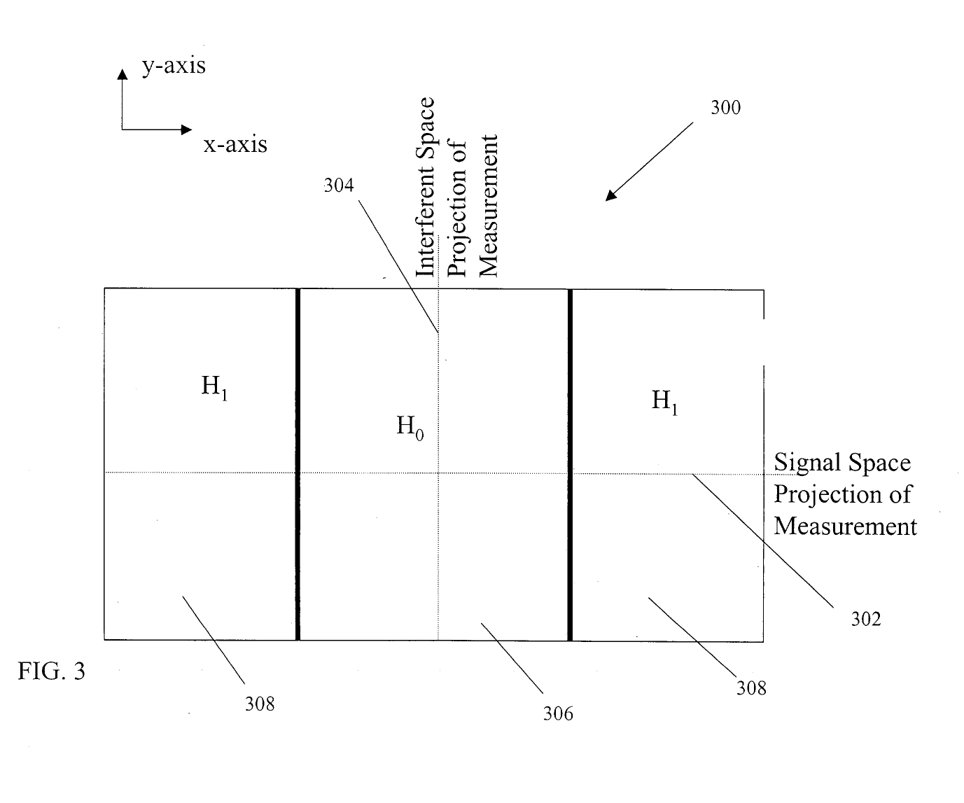

By way of example, FIGS. 3-6 represent graphical illustrations of a two dimensional space (two dimensional plane of two vectors that are associated with a given measurement and its projection on the signal space). Measurement signals (sets of measurement data) that lie in the regions marked H₀ indicate the absence of a particular signal of interest within the measurement data. Further, measurement signals that lie in the regions marked H₁ indicate the presence of a particular signal of interest within the measurement data. The signal space projection component of the measurement data is represented by the x-axis and the interferent space projection component of the measurement is represented by the y-axis. For a given decision threshold, the associated constant likelihood ratio surface divides the measurement space into a signal present (H₁) region, and a signal absent (H₀) region. The shape and size of the regions specify conditions under which a detector will indicate the presence and/or absence of a particular signal of interest within a set of measurement data.

The illustrative method of hypothesis testing includes formulating a generalized model of a set of measurement data:

$$\begin{matrix}x = {r}_{s} + {r}_{u} + n \\ = S θ + U ψ + ω v\end{matrix} \qquad ( 1 )$$

where x is a measurement vector, rₛ is a component of the measurement data that represents a signal of interest, rᵤ is a component of the measurement data that represents unlearned interferents, and n is a component that represents noise. The measurement x is a vector that is (K×1) in size.

Interferents are signals (or components of measurement data) that are not generally attributable to, for example, the source of the signal of interest. Unlearned interferents are those signals that an operator or a signal detector processor, for example, has not experienced before and whose characteristics are not known. Learned interferents, alternatively, are those signals that an operator, for example, has experienced before and whose characteristics are known or can be modeled. Noise is a signal (or component of measurement data) that is, for example, electrical noise attributable to the electrical hardware used to measure the measurement data.

S is a matrix whose columns span the signal space of the particular signal of interest. U is a matrix whose columns span the interferent space. The interferent space is orthogonal to the signal space. The signal of interest rₛ resides in a N-dimensional subspace spanned by the columns of the known K×N matrix S, and has an unknown associated gain vector θ. The unlearned interferents lie in the interferent space U orthogonal to the signal subspace S. Therefore, the presence of the unlearned interferents is mathematically derived from the projection of the measurement vector x onto the interferent space U spanned by the columns of U.

The (K−N) dimensional subspace of unlearned interferents is denoted by u. u is spanned by the columns of the matrix U. Associated with rᵤ is an unknown gain vector ψ of length (K−N). The noise vector n is a (K×1) random vector modeled as n=ωv, where w is either a known or unknown width factor that is proportional to the standard deviation, and v is a (K×1) random vector of zero mean and unit covariance whose elements are assumed to be independent and identically distributed.

Derivation of a hypothesis test also involves creating an estimate of, for example, the noise by approximating the noise as a probability density function. A probability density function g(y), for example, is a mathematical equation that identifies the probability of occurrence of each possible value of y. To derive the hypothesis test the following assumptions are made with respect to the noise density function for noise v denoted by ƒᵥ(v):

1. ƒᵥ(v)=ƒᵥ(d(v)), where d(v) is a metric-like non-negative scalar valued function of v satisfying d(0)=0, and d(v)>0. For example, d(v) may, but is not restricted to be a norm of v.

2. ƒᵥ is non-increasing in d(v), so that if d(v₁)≦d(v₂), then _{ƒv}(v₁)≧ƒᵥ(v₂). As a result of these assumptions, ƒᵥ reaches its maximum at v=0. The above assumptions are not restrictive and include a large family of density functions, such as the generalized Gaussian probability density functions (pdf's), and others. A Gaussian probability density function, for example, represents a normal distribution (bell shaped curve) of a given mathematical variable (e.g., y). Other types of density functions include non-Gaussian (which includes generalized Gaussian and Laplacian) each of which has a different mathematical equation that describes the probability of occurrence of a given variable (e.g., y) value.

In the following family of hypothesis tests, H₀ states that the signal of interest is not present in the measurement vector, while H₁ states that the signal of interest is present in the measurement vector. For hypotheses H₀ and H₁, u₀ and u₁ denote the subspaces of unlearned effects spanned by the columns of U₀ and U₁, respectively, and for any matrix W, N(W) denotes its null subspace. The following hypothesis test is employed

H₀:x=U₀ψ₀+ω₀v₀, u₀ [symbol] N(S) (2)

H₁:x=Sθ+U₁ψ₁+ω₁v₁, u₁⊂N(S) (3)

The conditions on the dimensions of the subspaces U₀ and u₁ for the unlearned effects are needed for the hypotheses test to be mathematically well posed. For the measurements to affect the decision, the followings two conditions are adopted,

1. For hypothesis H₀, Rank (U₀)<K. This gives u₀ [symbol] N(S). The inclusion is not strict since the dimension of N(S) is no greater than K−N.

2. Similarly, for hypothesis H₁, Rank ([S, U₁])<K. This implies that u₁⊂N(S).

The largest possible subspace spanned by the columns of U₀ has dimension K−N, and is uniquely determined; it is the entire null space N(S). The largest subspace that can be spanned by the columns of U₁, however, is not uniquely determined, as it can be any subspace of dimension as large as K−N−1 contained in N(S). In the above, the columns of S are assumed to be independent.

The formulation of equations (2) and (3) is a general one that embraces many varieties of hypothesis tests. Some of these varieties are summarized in Tables 1 and 2 and represent one dimensional (matched filter) vs. multidimensional (matched subspace) signal space detection. Matched subspace detection involves recognizing the presence of a signal that is expected to lie in a particular subspace of the measurements or observations. If the subspace is one-dimensional (the signal lies along a particular direction), the type of detection employed is known as matched filter detection.

Various classes of detectors exist depending upon whether certain components (e.g., interferents) of the measurement data are known or unknown. Optimal detectors are those detectors designed for and/or employed in the absence of consideration for the possible presence of unlearned interferents. Robust detectors, alternatively, are designed for and/or employed when interferents are unlearned (unknown). If unlearned interferents are not considered, then U₀=U₁=0, and an optimal subspace detector is derived rather than a robust subspace detector. Further, constant false alarm rate (CFAR) detectors may be employed when the width factors ω₀ and ω₁ are unknown.

Tables 1 and 2 also provide reference to the expressions that represent Gaussian (based on Gaussian pdf's) and non-Gaussian (based on generalized Gaussian or other pdf's) detectors, respectively.

TABLE 1
Gaussian Detectors

| Signal | Variance | Optimal | Robust |
|---|---|---|---|
| Space | σ² | Gaussian | Gaussian |
| Matched | known | λ_{2,ok} = x′P_{S}x/(2σ²) | λ_{2,rk} = x′(P_{S} − P_{U})x/(2σ²) |
| filter | | | |
| (1 -D | unknown | λ_{2,ou} = csc(<x,s>) | λ_{2,ru} = cot(<x,s>) |
| signal | CFAR | | |
| space) | | | |
| Matched | known | Λ_{2,ok} = x′P_{S}x/(2σ²) | Λ_{2,rk} = x′(P_{S} − P_{U})x/(2σ²) |
| subspace | | | |
| (multi-D | unknown | Λ_{2,ow} = x′x/x′P_{U}x | Λ_{2,rw} = x′P_{S}x/x′P_{U}x |
| signal | | | |
| space) | CFAR | | |

TABLE 2
Generalized Gaussian Detectors

| Signal | Width | Generalized | Robust Generalized |
|---|---|---|---|
| Space | Factor ω | Gaussian | Gaussian |
| Matched filter (1-D signal space) | known | ${λ}_{p , ok} = - {( \frac{1}{{ω}_{1}} {‖ x - s {\hat{θ}}_{p} ‖}_{p} )}^{p} + {( \frac{1}{{ω}_{0}} {‖ x ‖}_{p} )}^{p}$ | ${λ}_{p , rk} = - {( \frac{1}{{ω}_{1}} {‖ x - s {\hat{θ}}_{p} ‖}_{p} )}^{p} + {( \vert {s}^{′} x \vert / {‖ {ω}_{0} s ‖}_{q} )}^{p}$ |
| | unknown | ${λ}_{p , ou} = {‖ x ‖}_{p} / {‖ x - s {\hat{θ}}_{p} ‖}_{p}$ | ${λ}_{p , ru} = \vert {s}^{′} x \vert / ( {‖ s ‖}_{q} {‖ x - s {\hat{θ}}_{p} ‖}_{p} )$ |
| Matched subspace (multi-D signal space) | known | ${Λ}_{p , ok} = - {( \frac{1}{{ω}_{1}} {‖ x - S {\hat{θ}}_{p} ‖}_{p} )}^{p} + {( \frac{1}{{ω}_{0}} {‖ x ‖}_{p} )}^{p}$ | ${Λ}_{p , ru} = - {( \frac{1}{{ω}_{1}} {‖ x - S {\hat{θ}}_{p} ‖}_{p} )}^{p} + {( \frac{1}{{ω}_{0}} {‖ x - U {\hat{ψ}}_{p} ‖}_{p} )}^{p}$ |
| | unknown | ${Λ}_{p , ou} = {‖ x ‖}_{p} / {‖ x - S {\hat{θ}}_{p} ‖}_{p}$ | ${Λ}_{p , ru} = {‖ x - U {\hat{ψ}}_{p} ‖}_{p} / {‖ x - S {\hat{θ}}_{p} ‖}_{p}$ |

### Robust Detection Test Formulation

Robust detectors may be utilized in signal detection when the measurement data contains unlearned interferents. In the presence of unlearned interferents the generalized likelihood ratio test for equations (2) and (3) represented as a function of the matrices U₀ and U₁ are given by

$$Λ ( x \text{;} {U}_{0} , {U}_{1} ) = \frac{{max}_{{θ}_{1} , {ψ}_{1} , {ω}_{1}} f ( x \vert {U}_{1 ,} {θ}_{1} , {ψ}_{1} , {ω}_{1} , {H}_{1} )}{{max}_{{ψ}_{0} , {ω}_{0}} f ( x \vert {U}_{0 ,} {ψ}_{0} , {ω}_{0} , {H}_{0} )} \qquad ( 4 )$$

where ƒ(x|U_{0,}ψ₀,ω₀,H₀) and ƒ(x|U_{1,}θ₁,ψ₁,ω₁,H₁) are the conditional density functions of the observations for hypotheses H₀ and H₁, respectively. To obtain robustness to unlearned interferents while maintaining sensitivity to the signal of interest, U₀ᵣ, U₁ᵣ is given by

$$\begin{matrix}{U}_{{0}_{r}} = arg { max}_{{U}_{0}} {max}_{{ψ}_{0} , {ω}_{0}} f ( x \vert {U}_{0 ,} {ψ}_{0} , {ω}_{0} , {H}_{0} ) & ( 5 ) \\ {U}_{{1}_{r}} = arg { min}_{U} {max}_{{θ}_{1} , {ψ}_{1} , {ω}_{1}} f ( x \vert {U}_{1 ,} {θ}_{1} , {ψ}_{1} , {ω}_{1} , {H}_{1} ) & ( 6 )\end{matrix}$$

The optimization problem of equations (5) and (6) are the solved as shown below. For hypothesis H₁, the likelihood function is expressed as

$${l}_{{r}_{1}} ≡ {min}_{{U}_{1}} {max}_{{θ}_{1} , {ψ}_{1} , {ω}_{1}} f ( x \vert {U}_{1 ,} {θ}_{1} , {ψ}_{1} , {ω}_{1} , {H}_{1} ) \qquad ( 7 )$$

As previously mentioned herein, the columns of U₁ cannot span the entire null space of S, N(S). To determine U₁, based on the prior noise assumptions and equation (1), the underlying density function is of the form

$$\begin{matrix}f ( x \vert {U}_{1 ,} {θ}_{1} , {ψ}_{1} , {ω}_{1} , {H}_{1} ) = f ( d ( v ) \vert {U}_{1 ,} {θ}_{1} , {ψ}_{1} , {ω}_{1} , {H}_{1} ) \\ = f ( d ( x - S {θ}_{1} - {U}_{1} {ψ}_{1} ) \vert {ω}_{1} , {H}_{1} )\end{matrix}$$

It is also necessary to define

ζ=x−Sθ₁*

where θ₁* is the result of the maximization in equation (7). Based upon the properties of the noise density function, ψ₁* and U₁ᵣ in equation (6) are determined by maximizing the density function ƒ or minimizing the function d

$$\begin{matrix}( {U}_{1 r , } {ψ}_{1}^{*} ) = arg ( {min}_{{U}_{1}} {max}_{{ψ}_{1}} f ( d ( ζ - {U}_{1} {ψ}_{1} ) ) ) \\ = arg ( {max}_{{U}_{1}} {min}_{{ψ}_{1}} d ( ζ - {U}_{1} {ψ}_{1} ) )\end{matrix} \qquad ( 8 )$$

But, note that

$${min}_{{ψ}_{1}} d ( ζ - {U}_{1} {ψ}_{1} ) \leq d ( ζ )$$

So U₁=0 provides an upper bound for d, yielding

$${max}_{{U}_{1}} {min}_{{ψ}_{1}} d ( ζ - {U}_{1} {ψ}_{1} ) = d ( ζ )$$

or equivalently

$${min}_{{U}_{1}} {max }_{{ψ}_{1}} f ( d ( ζ - {U}_{1} {ψ}_{1} ) ) = f ( d ( ζ ) )$$

The terms involving ψ₁ are removed from the hypothesis H₁, A similar step is employed for hypothesis H₀ and minimizing over U₀ yields a matrix U₀ᵣ whose columns span the entire subspace N(S).

The robust detection test is written as

H₀:x=Uψ+ω₀v₀, u=N(S) (9)

H₁:x=Sθ+ω₁v₁ (10)

The robust detection test tests whether the measurement data is due to the unlearned effects (i.e., θ=0) or due to the signal of interest (i.e., ψ=0). To simplify notation, the subscript 0 is omitted from the interferent space so that U=U₀ and u=u₀.

When ψ≡0 in hypothesis H₀, then an optimal detection test exists as a special case of the robust detection test. When the noise is Gaussian and the width factors ωᵢ, i=0, 1, or equivalently the variances are unknown, then the robust formulation is not needed. Whether ψ=0 or not, CFAR detectors based on Gaussian noise models are obtained and the detectors have substantially equivalent performance characteristics. The detectors may be represented by the t statistic if S is one dimensional, or represented by the F statistic if S is multi-dimensional.

When the noise is Gaussian and the variance is unknown, the CFAR detector is expressed in terms of the t statistic if the signal space is one-dimensional or expressed in terms of the F statistic if the signal space is multidimensional. These t and F statistics have a well known geometric interpretation. Specifically, they are functions of the angle separating the measurement vector and the signal subspace. Aside from the insight it provides into detection problems, this geometric interpretation enables the t and F statistics to be the solution to both the optimal and robust subspace detection problems. Specifically, the solution to the optimal problem is the cosecant of this angle, while the solution of the robust detection problem is the cotangent of the same angle. As a result, the optimal and robust CFAR detectors in the presence of Gaussian noise produce the same receiver operating characteristic (ROC) performance curve, meaning they offer the same tradeoff between the probabilities of detection and false alarm. When considering the Gaussian CFAR detection problem, the need to explicitly account for the presence of interference and distinguish between the optimal and robust problem does not arise.

Though in the Gaussian case, CFAR optimal and robust detectors are equivalent from the point of view of performance, such is not the case when the noise variance is known, nor is it the case when the noise is non-Gaussian, whether the variance is known or unknown.

When the noise is Gaussian and the variance is known, the optimal subspace detector, which does not account for interferents, is typically expressed in terms of a X² statistic. When interferents are present, the robust formulation of the subspace detection leads to a statistic that is more general than the optimal detector's statistic. When the noise is non-Gaussian, the optimal and robust detection problems are distinct as well.

Generalized Gaussian Probability Density Functions (pdf's)

The family of generalized Gaussian density functions (mathematical equation that identifies the probability of occurrence of each possible value of, for example, the noise in measurement data) are utilized in deriving specific expressions for GLR detectors. The robust detection test of equations (9) and (10) is applicable to the general class of unimodal noise density functions described herein. For a K-dimensional random vector x, the generalized Gaussian density function is defined as

$${f}_{p} ( x \vert m , ω ) = {( \frac{p}{2 ω Γ ( 1 / p )} )}^{K} exp ( - {( \frac{{‖ x - m ‖}_{p}}{ω} )}^{p} ) , p ∈ ( 0 , ∞ ) \qquad ( 11 )$$

where Γ is the Gamma function given by

$$Γ ( k ) = {\int }_{0}^{∞} {t}^{k - 1} exp ( - t ) ⅆ t$$

and for an arbitrary vector y, ∥y∥ₚ is defined as

$${‖ y ‖}_{p} = {( {\sum }_{i} {\vert {y}_{i} \vert}^{p} )}^{\frac{1}{p}} \qquad ( 12 )$$

Here m, ω and p are respectively the location, width factor and shape or decay parameters of the density function in equation (11). For any p, the width parameter ω is proportional to the standard deviation σ. Specifically,

$$ω = {σ ( \frac{Γ ( 1 / p )}{Γ ( 3 / p )} )}^{\frac{1}{2}}$$

In particular, the Laplacian and Gaussian density functions with standard deviation σ are obtained when (p,ω)=(1,σ\sqrt{2}) and (p,ω)=(2,σ\sqrt{2}), respectively. The uniform density function may be approximated by large values of p. The parameter p is used to trade off between sensitivity and robustness of the detector. Decreasing p increases robustness of the detector to tail events or outliers, while increasing p increases sensitivity of the detector. For p≧1, equation (12) represents a norm. While the width factor ω and the location parameter m may be estimated, in this embodiment of the method the parameter p is known.

The location parameter estimate is dependent on the choice of p. If p<1, the estimate will be located within the largest cluster of measurements. If p=1, the estimate will be the median. If p=2, the estimate is the mean. This limits the ability of the detector to correctly capture the characteristics of the noise in the measurement. The decreased robustness will, for example, increase the likelihood that the detector will mistake the noise for the presence of the signal of interest. When p=∞, the estimate consists of the midpoint of the minimum and maximum of the measurements. Thus, while lower values of p tend to produce an estimate by the detector that is unaffected by outliers, a higher value of p leads to an estimate that is sensitive to the outliers. The shape parameters may be used as a design option. For example, when an operator believes that outliers are a concern, values of p≦1 may be utilized in formulating the detector test.

Optimal and Robust Matched Filter Detection: Known ω

When the width factor is known, the log likelihood ratio (omitting a constant term) for the robust (interferent is unknown) matched filter detector (U≠0 equation (10)) (also referring to Table 2) is given by

$$\begin{matrix}{λ}_{p , rk} ( x ) = log \frac{exp ( - {‖ x - s {\hat{θ}}_{p} ‖}_{p}^{p} / {ω}_{1}^{p} )}{exp ( - {‖ x - U {\hat{ψ}}_{p} ‖}_{p}^{p} / {ω}_{0}^{p} )} \\ = - {( \frac{1}{{ω}_{1}} {‖ x - s {\hat{θ}}_{p} ‖}_{p} )}^{p} + {( \frac{1}{{ω}_{0}} {‖ x - U {\hat{ψ}}_{p} ‖}_{p} )}^{p}\end{matrix} \qquad ( 13 )$$

where the subscript r is for robust, the subscript k signifies that the parameter ω is known, \hat{θ}ₚ and \hat{ψ}ₚ are the maximum likelihood estimates of θ and ψ, respectively. The matrix S is represented by s to emphasize that the matrix is one-dimensional. When there are no interferents and U≡0, an optimal matched filter detector (also referring to Table 2) results

$${λ}_{p , ok} = - {( \frac{1}{{ω}_{1}} {‖ x - s {\hat{θ}}_{p} ‖}_{p} )}^{p} + {( \frac{1}{{ω}_{0}} {‖ x ‖}_{p} )}^{p} \qquad ( 14 )$$

where the subscript o is for optimal. For the Gaussian case, when p=2 and ω₀=ω₁, the expressions for equations (13) and (14) become (as a function of the common variance σ²), respectively,

$$\begin{matrix}{λ}_{2 , rk} ( x ) = \frac{1}{2 {σ}^{2}} {x}^{′} ( {P}_{s} - {P}_{U} ) x & ( 15 ) \\ {λ}_{2 , ok} ( x ) = \frac{1}{2 {σ}^{2}} {x}^{′} {P}_{s} x & ( 16 )\end{matrix}$$

where the superscript ′ stands for transpose and, for an arbitrary matrix W, the projection matrix is given by P_{w}≡W(W′W)⁻¹W′. The above X² statistic of equation (16) is equivalent in performance to the Gaussian noise based statistic that may be used with matched filter detection:

$$\frac{{s}^{′} {P}_{s} x}{σ \sqrt{{s}^{′} s}}$$

The computation of λ_{p,ok} in equation (14) involves a search for the scalar \hat{θ}ₚ in a one-dimensional space s. By contrast, the computation of λ_{p,rk} in equation (13) requires additionally, determination of vector \hat{ψ}ₚ in the K−1 dimensional space spanned by the columns of U. To avoid the need for this computation associated with the determination of the residual ∥x−U\hat{ψ}ₚ∥ the following lemma is employed.

### Lemma 1

h and η are column vectors and

$${J}_{p} ( η ) = {‖ η ‖}_{p}^{p} , p ∈ ( 0 , ∞ ) \qquad ( 17 )$$

The constrained optimization problem

$${min}_{η} {J}_{p} ( η ) \qquad ( 18 )$$

subject to the constraint

h′η=b (19)

has as a solution

Jₚ*=(|b|/∥h∥_{q})^{p} (20)

where q=p/(p−1) for p>1, and q≡∞otherwise. This optimum is reached at

$$\begin{matrix}1. For p > 1 \\ {η}_{i} = b \frac{sgn ( {h}_{i} ) {\vert {h}_{i} \vert}^{( 1 / ( p - 1 ) )}}{{‖ h ‖}_{q}^{q}} & ( 21 ) \\ 2. For p \leq 1 \\ {η}_{i} = \{ \begin{matrix}b / {h}_{i} & if & \vert {h}_{i} \vert = {max}_{j} \vert {h}_{j} \vert \\ 0 & & otherwise\end{matrix} & ( 22 )\end{matrix}$$

To apply the lemma (further details of which are provided herein) and obtain a simpler expression of λ_{p,rk}, h is identified with the signal space vector s, and η with x−Uψ. Noting that the columns of U are orthogonal to s,

$$\begin{matrix}{h}^{′} η = {s}^{′} ( x - U ψ ) \\ = {s}^{′} x \\ = b\end{matrix} \qquad ( 23 )$$

As a result, the detector statistic λ_{p,rk} simplifies to

$${λ}_{p , rk} ( x ) = - {( \frac{1}{{ω}_{1}} {‖ x - s {\hat{θ}}_{p} ‖}_{p} )}^{p} + {( \frac{1}{{ω}_{0}} \frac{{s}^{′} x}{{‖ s ‖}_{q}} )}^{p} \qquad ( 24 )$$

The advantage of this simplified form is the elimination of residual computation in the larger dimensional subspace U spanned by the columns of u, while the computation of \hat{θ}ₚ takes place in a one-dimensional subspace.

Optimal and Robust CFAR Matched Filter Detection: Unknown ω

For the case where w is unknown, the generalized likelihood functions for each of the two hypotheses of the robust test are given by

$$\begin{matrix}{l}_{0} ( x ) = {max}_{ψ , {ω}_{0}} f ( x \vert ψ , {ω}_{0} , {H}_{0} ) & ( 25 ) \\ {l}_{1} ( x ) = {max}_{θ , {ω}_{1}} f ( x \vert θ , {ω}_{1} , {H}_{1} ) & ( 26 )\end{matrix}$$

The generalized likelihood ratio (GLR) of l₁ and l₀, taken to the power of 1/K leads to the robust (interferents are unknown) CFAR matched subspace detector expression (also referring to Table 2)

$${λ}_{p , ru} ( x ) = \frac{{‖ x - U {\hat{ψ}}_{p} ‖}_{p}}{{‖ x - s {\hat{θ}}_{p} ‖}_{p}} \qquad ( 27 )$$

Here the subscripts r and u are for robust and unknown parameter ω, respectively. In this instance, the log of the likelihood ratio is not used to obtain an expression in terms of the ratio of residuals. In the absence of unlearned interferents (U≡0) the optimal CFAR matched subspace detector (also referring to Table 2) becomes

$${λ}_{p , ou} ( x ) = \frac{{‖ x ‖}_{p}}{{‖ x - s {\hat{θ}}_{p} ‖}_{p}} \qquad ( 28 )$$

Computation of the above likelihood ratio requires only a search for \hat{θ}ₚ in the one-dimensional space s. To eliminate the search in the generally multidimensional space spanned by the columns of U in the CFAR robust detector of equation (27), Lemma 1 is applied:

$$\begin{matrix}{λ}_{p , ru} ( x ) = \frac{{‖ x - U {\hat{ψ}}_{p} ‖}_{p}}{{‖ x - s {\hat{θ}}_{p} ‖}_{p}} \\ = \frac{\vert {s}^{′} x \vert}{{‖ s ‖}_{q} {‖ x - s {\hat{θ}}_{p} ‖}_{p}}\end{matrix} \qquad ( 29 )$$

In the Gaussian case, equations (29) and (28) become, respectively,

$$\begin{matrix}\begin{matrix}{λ}_{2 , ru} ( x ) = \frac{{x}^{′} {P}_{s} x}{{x}^{′} {P}_{U} x} \\ = cot ( \text{<} x , s \text{>} ) \\ {λ}_{2 , ou} ( x ) = \frac{{x}^{′} x}{{x}^{′} {P}_{U} x}\end{matrix} & ( 30 ) \\ = csc ( \text{<} x , s \text{>} ) & ( 31 )\end{matrix}$$

where <x,s> denotes the angle between x and s. Thus, in the Gaussian case, the optimal detector is the cosecant of the angle between the measurement x and the signal subspace s, while the robust detector is the cotangent of the same angle. The underlying statistic is thus the angle between x and s, and the two detectors thus provide the same performance.

This is not the case, however, for an arbitrary value of the parameters p≠2. Specifically,

$$\frac{{λ}_{p , ru}}{{λ}_{p , ou}} = κ ( x , s , p ) cos ( \text{<} x , s \text{>} ) \qquad ( 32 )$$

where κ(x,s,p) is given by

$$κ ( x , s , p ) ≡ \frac{{‖ s ‖}_{2} {‖ x ‖}_{2}}{{‖ s ‖}_{q} {‖ x ‖}_{p}} \qquad ( 33 )$$

As described below, the performance of the robust and optimal CFAR detectors are not necessarily the same when p≠2. In addition, when p=2, as equations (30) and (31) indicate, the two CFAR detectors are invariant to the magnitude of the measurement, so they are scale invariant. They are also rotation invariant. By contrast, for a general p, while the two CFAR detectors are scale invariant, they are not rotation invariant. They are invariant to specific transformations that leave the ratio of the p-norm of residuals unchanged.

### Matched Subspace Detection

In the robust case, unlearned interferents are assumed present (U≠0). In the conventional case, unlearned interferents are assumed absent (U≡0). When scale parameter ω is known, the method of the invention involves a subspace detection problem. When ω is unknown, the method of the invention involves constant false alarm rate (CFAR) subspace detection. In general, to generate the expressions governing theses methods of detection it is necessary to perform a search for maximum likelihood estimates in the signal space and the unknown interferent space, both of which are of higher dimensions.

### Optimal and Robust Subspace Detection: Known ω

In this aspect of the invention, the noise scale parameter ω is known, the signal response space S is multidimensional, and unlearned interferents may be present (robust) or absent (optimal). When U≠0 (robust detection test) the robust log-likelihood ratio for the detection test (equations (9) and (10)) is given by (also referring to Table 2)

$${Λ}_{p , rk} ( x ) = - {( \frac{1}{{ω}_{1}} {‖ x - s {\hat{θ}}_{p} ‖}_{p} )}^{p} + {( \frac{1}{{ω}_{0}} {‖ x - U {\hat{ψ}}_{p} ‖}_{p} )}^{p} \qquad ( 34 )$$

where Λ_{p,rk} is utilized instead of λ_{p,rk} to designate the GLR for the case of multidimensional signal spaces. For the cases where U≡0, the robust detector reduces to the optimal detector (also referring to Table 2)

$${Λ}_{p , ok} ( x ) = - {( \frac{1}{{ω}_{1}} {‖ x - s {\hat{θ}}_{p} ‖}_{p} )}^{p} + {( \frac{1}{{ω}_{0}} {‖ x ‖}_{p} )}^{p} \qquad ( 35 )$$

When p=2 and ω₂=ω₁, equation (34) may be written in terms of the common standard deviation σ as (also referring to Table 1)

$${Λ}_{2 , rk} ( x ) = \frac{1}{2 {σ}^{2}} ( {x}^{′} ( {P}_{S} - {P}_{U} ) x \qquad ( 36 )$$

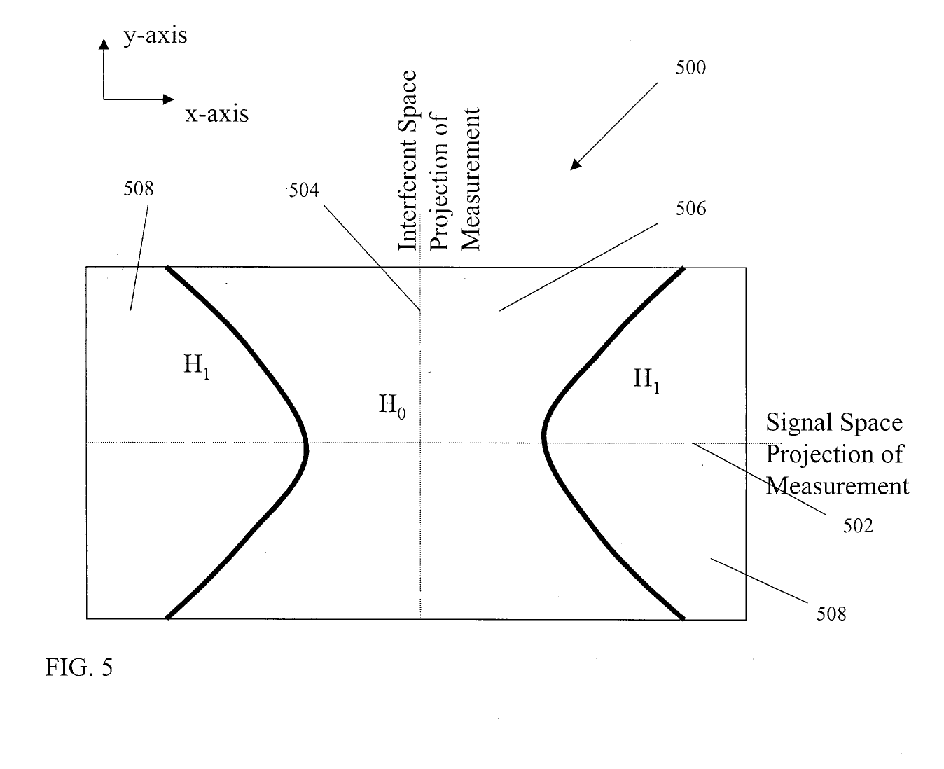

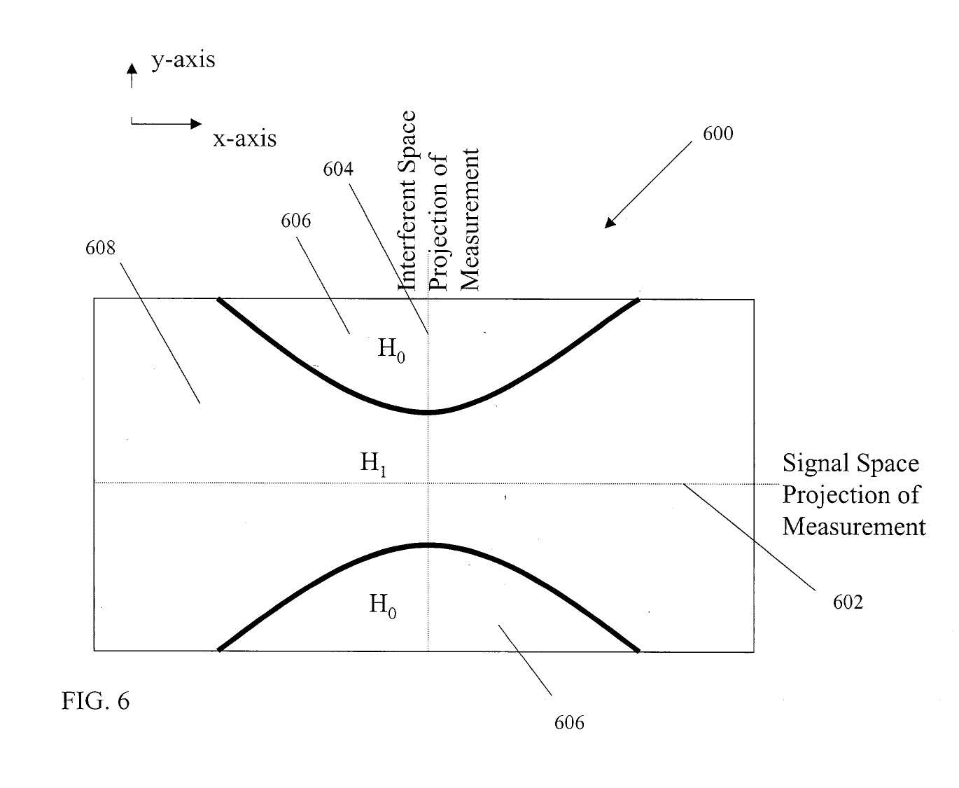

The robust detector Λ_{2,rk} of equations (15) and (36) is a function of the measurement's projections onto both the signal and interferent subspaces. Its constant value surfaces are hyperbolic, as specified by equation (15). Two different types of hyperbolic surfaces result, depending on whether Λ_{2,rk}>0 (FIG. 5), or Λ_{2,rk}<0 (FIG. 6).

Referring to FIG. 5, the signal space projection of measurement 502 of graph 500 is represented by the x-axis and the interferent space projection of the measurement 504 is represented by the y-axis. The signal present regions 508 are designated by H₁. The signal absent regions 506 are designated H₀. Measurements falling outside the region 506 would indicate the presence of the signal of interest in the set of measurement data. Referring now to FIG. 6, the signal space projection of measurement 602 of graph 600 is represented by the X-axis and the interferent space projection of measurement 604 is represented by the y-axis. The signal present regions 608 are designated by H₁. The signal absent regions 606 are designated H₀. Measurements falling outside the region 506 would indicate the presence of the signal of interest in the set of measurement data.

In the absence of unknown interferents, ψ=0, the above expression reduces to X² statistic used with Gaussian matched subspace detection

$${Λ}_{2 , o k} ( x ) = \frac{{x}^{′} {P}_{S} x}{2 {σ}^{2}} \qquad ( 37 )$$

For an optimal detector, Λ_{2,ok} is a function of the measurement's projection onto the signal space, as specified by equations (16) and (37). The signal space projection of measurement 302 of graph 300 is represented by the x-axis and the interferent space projection of measurement 304 is represented by the y-axis. The signal present regions 308 are designated by H₁. The signal absent regions 306 are designated H₀. Measurements falling outside the region 306 would indicate the presence of the signal of interest in the set of measurement data.

Thus, as is the case with matched filter detection, two matched subspace detectors can be derived, a robust one or an optimal one, even when the noise is Gaussian. The location parameter estimates \hat{ψ}ₚ,\hat{θ}ₚ may be computed numerically, and where closed forms for the probability density functions are not available, these may be obtained by simulation.

### Optimal and Robust CFAR Subspace Detection: Unknown ω

When ω is unknown, the generalization of equation (27) to matched subspaces yields a robust detector (interferents are unknown) of the form (also referring to Table 2):

$${Λ}_{p , r u} ( x ) = \frac{{‖ x - U {\hat{ψ}}_{p} ‖}_{p}}{{‖ x - S {\hat{θ}}_{p} ‖}_{p}} \qquad ( 38 )$$

In the absence of unlearned interferents, the generalization of equation (28) yields an optimal detector (no unknown interferents) of the form (also referring to Table 2)

$${Λ}_{p , o u} ( x ) = \frac{{‖ x ‖}_{p}}{{‖ x - S {\hat{θ}}_{p} ‖}_{p}} \qquad ( 39 )$$

CFAR detectors are scale invariant and are invariant to any transformation that leaves the ratio of the p norms unchanged. For the Gaussian case, the robust detector statistic of equation (39) becomes (also referring to Table 1)

$${Λ}_{2 , r u} ( x ) = {( \frac{{x}^{′} {P}_{S} x}{{x}^{′} {P}_{U} x} )}^{1 / 2} \qquad ( 40 )$$

This statistic is then equivalent in performance to the F-statistic with N and K−N degrees of freedom, or

$$F = {Λ}_{2 , r u}^{2} \times \frac{K - N}{K} \qquad ( 41 )$$

In the absence of unlearned interferents when U≡0, the CFAR counterpart of equation (37) when σ is unknown yields a detector of the form (also referring to Table 1)

$${Λ}_{2 , o u} ( x ) = {( \frac{{x}^{′} x}{{x}^{′} {P}_{U} x} )}^{1 / 2} \qquad ( 42 )$$

This detector can, alternatively, be related to the F statistic. As with matched filter detection, the optimal statistic of equation (42) is equivalent to the robust statistic of equation (40), in which there is a one-to-one correspondence between the two expressions, because

x′x=x′(P_{U}+P_{S})x (43)

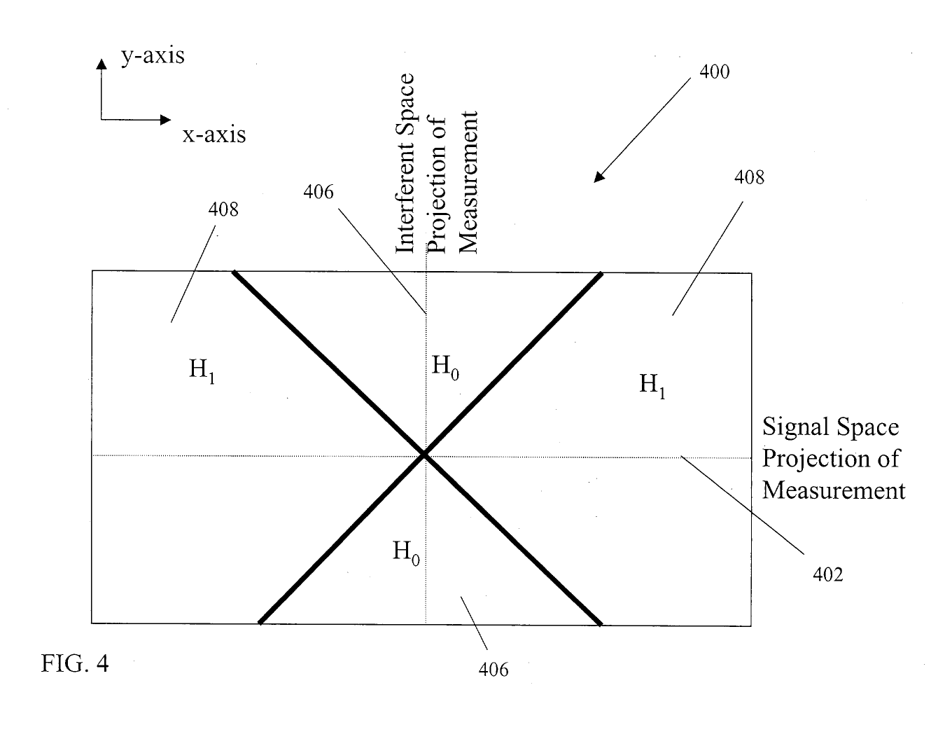

The decision regions for the two CFAR detectors Λ_{2,ou} and Λ_{2,ru} are shown in FIG. 4. The signal space projection of measurement 402 of graph 400 is represented by the x-axis and the interferent space projection of measurement 404 is represented by the y-axis. The signal present regions 408 are designated by H₁. The signal absent regions 406 (designated H₀) are defined by two two-dimensional cone-shaped regions each with their vertex at the origin of the graph, as specified by equations (30) and (31). Only in the Gaussian case are the two CFAR detectors equivalent in their performance.

### One-Dimensional Interferent Subspaces

In another aspect of the invention, the method involves use of a matched subspace detector in which the dimension of the signal space is one less than that of the measurement space. With respect to the notation introduced in equation (1), K−N=1 is the dimension of the interferent subspace U and U=U for the spanning vector. Applying the Lemma 1 yields u′(x−S\hat{θ}ₚ)=u′x. Thus, by analogy with equations (24) and (29), the robust detectors, denoted \check{λ}_{p,ou} and \check{λ}_{p,ru} are, respectively, given by

$$\begin{matrix}{\breve{λ}}_{p , ru} = - {( \frac{1}{{ω}_{1}} \vert {u}^{′} x \vert )}^{p} + {( \frac{1}{{ω}_{0}} {‖ x - u {\hat{ψ}}_{p} ‖}_{p} )}^{p} & ( 44 ) \\ {\breve{λ}}_{p , ru} = \frac{{‖ u ‖}_{q} {‖ x - u {ψ}_{p} ‖}_{p}}{\vert {u}^{′} x \vert} & ( 45 )\end{matrix}$$

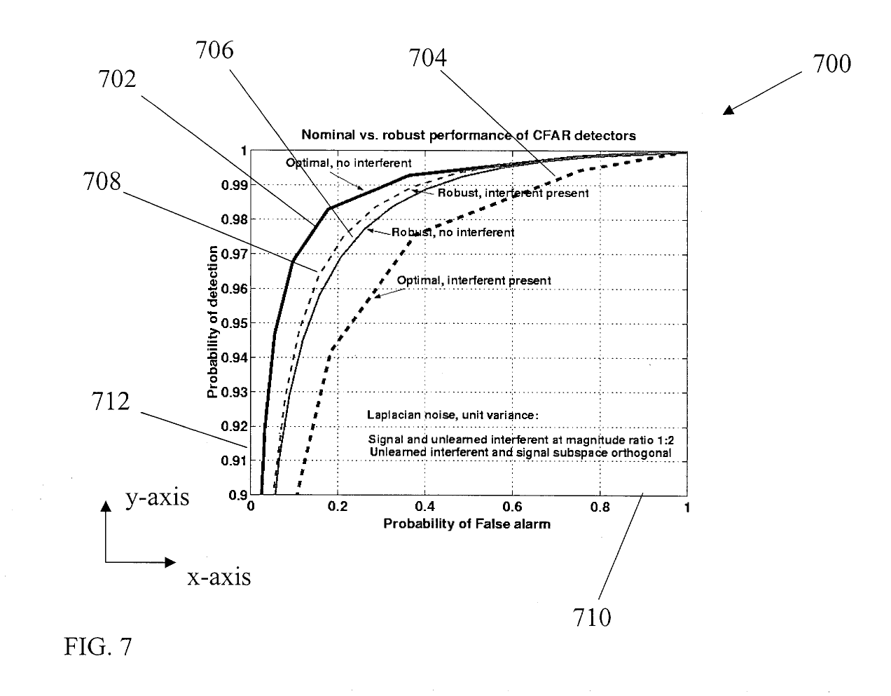

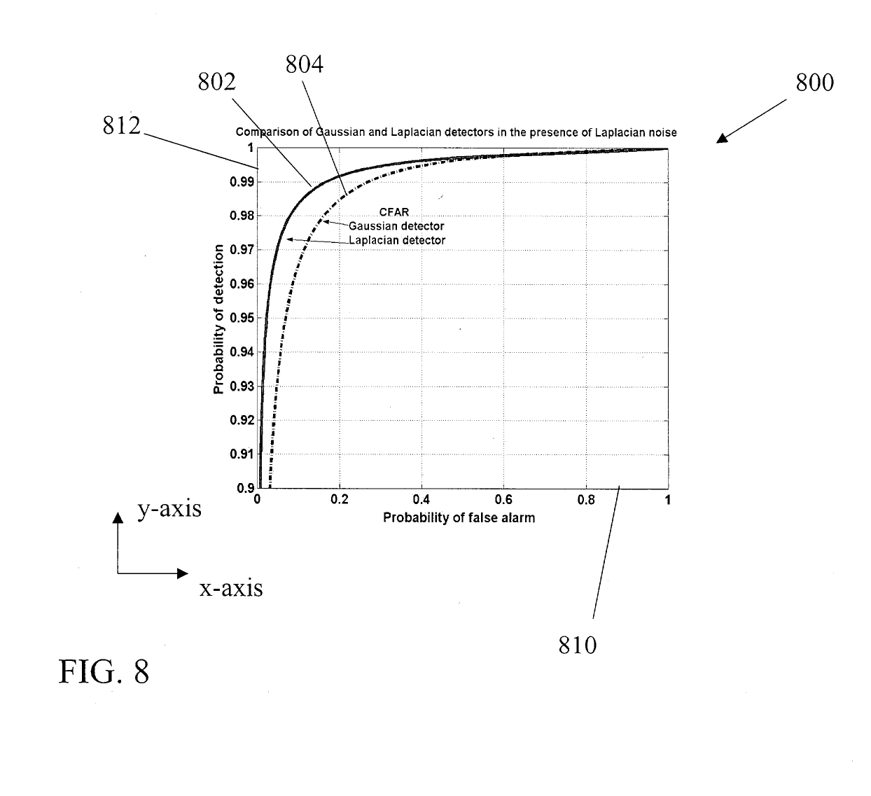

By mathematically simulating the probability density functions of the matched filter detectors' statistics, the detectors' performance with respect to ROC performance in the presence and absence of interferents is provided, referring now to FIG. 7. The ROC performance of Gaussian and non-Gaussian detectors when the noise is not Gaussian is illustrated in FIG. 8.

Graph 700 of FIG. 7 compares the optimal λ_{1,ou} and robust λ_{1,ru} CFAR Laplacian detectors (p=1) in the presence of Laplacian noise under two different conditions: interferent absent and interferent present. Underlying noise in the measurement is Laplacian with unit variance. The x-axis 710 of the graph 700 represents the probability of false alarm (probability that the detector incorrectly detects the presence of the signal of interest). The y-axis 712 of the graph 700 represents the probability of detection (probability that the detector correctly detects the presence of a signal of interest).

Referring to FIG. 7, the optimal detector λ_{1,ou} 702 in the absence of unlearned interferents is labeled as “optimal, no interferents.” The optimal detector λ_{1,ou} 704 in the presence of an unlearned interferent signal of magnitude equal to twice that of the signal magnitude (ψ=2θ) is labeled “optimal, interferent present.” The robust detector λ_{1,ru} 706 in the absence of interferents is labeled “Robust, no interferent.” The robust detector λ_{1,ru} 708 in the presence of the unlearned interferent signal is labeled “Robust, interferent present.” Comparison of the four curves indicates that the robust detector in the presence of interferents yields a higher probability of detecting the presence of a particular signal of interest for a given probability of predicting a false alarm when compared with the optimal detector in the presence of interferents.

In other aspects of the invention, unlearned interferents may not degrade the performance of the optimal detector. In these cases, the optimal detector may yield better performance than the robust detector even in the presence of interferents. There may be cases, alternatively, where degraded performance of the robust detector in the absence of interferents is not significant to the performance of the detector, while at the same time the presence of interferents would degrade the performance of the optimal detector. In these cases, the robust detector might be the preferred detector for implementation.

Graph 800 of FIG. 8 shows two plots that compare the probability of detection vs. probability of false alarm of the Laplacian λ_{1,ou} and Gaussian λ_{2,ou} old CFAR detectors, respectively, in the presence of Laplacian noise (ω=0.707). The x-axis 810 of the graph 800 represents the probability of false alarm (probability that the detector incorrectly detects the presence of the signal of interest). The y-axis 812 of the graph 800 represents the probability of detection (probability that the detector correctly detects the presence of a signal of interest). Curve 802 represents the Laplacian detector (p=1), and curve 804 represents the Gaussian detector (p=2). The results illustrate for a given probability of false alarm the performance of a Gaussian detector represented by curve 804 will have a lower probability of detection than a Laplacian detector whose performance is represented by curve 802.

In another aspect of the invention, data regarding noise in the measurement is available and may be used to “train” the detector. The detector may be trained to reduce the likelihood that the detector will, for example, incorrectly detect the presence of a particular signal of interest due to the noise. The data regarding the noise and the density function used in the detector prior to acquiring knowledge about the noise would be used in formulating a generalized likelihood ratio for the detector. By way of example, a measurement training model may be specified by

x_{π}=s_{π}θ_{π}+v (46)

where the subscript π is for prior. Various generally known training model formulation can be used. If there is no learned interferent the GLR detector is specified by

$${Λ}_{π p} ( x ) = \frac{{max}_{θ , {0}_{π \cdot } {ω}_{1}} f ( x - s θ \vert {ω}_{1} , θ ) f ( {x}_{π} - {s}_{π} {θ}_{π} \vert {ω}_{1} , {θ}_{π} )}{{max}_{ψ , {θ}_{π \cdot } {ω}_{0}} f ( x - U ψ \vert {ω}_{0} , θ ) f ( {x}_{π} - {s}_{π} {θ}_{π} \vert {ω}_{0} , {θ}_{π} )} \qquad ( 47 )$$

Other variations are possible depending on the type of prior information available for the unknowns, including gains and variances for each hypothesis test. In another embodiment, noise data is used to train the detector when the quantity of measurement data is small, when the magnitude of the measurement data approaches the signal-to-noise ratio of the sensor, or when the CFAR detectors are used.

In another aspect of the invention, interferents reside in a known or learned subspace and the following model is used in place of equation (1)

$$\begin{matrix}x = {r}_{s} + {r}_{l} + {r}_{u} + n \\ = S θ + B φ + U ψ + ω v\end{matrix} \qquad ( 48 )$$

where r₁ is a component of the measurement due to known or learned interferents. The vector r₁ resides in a subspace spanned by the known columns of a (K×M) matrix B, and has unknown gain vector φ of length M. Learned interferents can, for example, include low frequency phenomena such as constant or predictable bias or ramps in the interferent signal. If the matrix B has been obtained from prior experiments the new measurement model would yield the following robust hypothesis test

H₀:x=Uψ+Bφ₀+ω₀v₀, u=N([S B]) (49)

H₁:x=Sθ+Bφ₁+ω₁v₁ (50)

The unlearned interferent subspace u, which is spanned by the columns of U, is orthogonal to the subspace spanned by the columns of both B and S.

By way of example, the detector λ_{p,ru} would then be expressed as

$${λ}_{p , ru} ( x ) = \frac{{‖ x - B {\hat{φ}}_{{0}_{p}} - U {\hat{ψ}}_{p} ‖}_{p}}{{‖ x - B {\hat{φ}}_{{1}_{p}} - s {\hat{θ}}_{p} ‖}_{p}} \qquad ( 51 )$$

In this aspect of the method of the invention the noise is not Gaussian (p≠2), and the Lemma 1 is applied to eliminate the need for computation in multidimensional spaces. (I−P_{B}) S is orthogonal to the matrix [B U], and by applying the Lemma 1 described herein the numerator of equation (51) is given by

$${‖ x - B {\hat{φ}}_{{0}_{P}} - U {\hat{ψ}}_{P} ‖}_{p} = \frac{\vert {s}^{′} ( I - {P}_{B} ) x \vert}{{‖ ( I - {P}_{B} ) s ‖}_{q}} \qquad ( 52 )$$

To eliminate the need for any computation in the learned interferent subspace spanned by the columns of B, the equation for the detector is projected onto the orthogonal subspace yielding an inequality equation for the H₁ hypothesis test in the denominator of equation (51):

∥x−B\hat{φ}₁ₚ−s\hat{θ}ₚ∥ₚ≦∥(I−P_{B})x−(I−P_{B})s\hat{θ}ₚ∥ₚ (53)

where the right hand side of equation (53) represents the residual obtained upon projecting onto the null space of the matrix B. Thus, with hypothesis H₁, eliminating computation in a higher dimensional space involves an approximation.

Equations (52) and (53) indicate a sequential processing approach. It is important to note that with learned subspaces only an approximation exists for hypothesis H₁'s residual, while the resulting expression for hypothesis H₀'s residual involves no approximation.

### Proof of Lemma 1

Where p>1, the Lagrangian for our constrained optimization problem, given by J_{P}≡∥η∥ₚ^{p}+γ(h′η−b), where γ is the Lagrange multiplier, is continuously differentiable for all η. The first order conditions,

$$\frac{\partial {J}_{p}}{\partial η} = 0$$

=0 can therefore be written as

sgn(ηᵢ)=sgn(γhᵢ) ∀i=1, . . . , N (54)

P|ηᵢ|^{(p-1)}=|γhᵢ| ∀i=1, . . . , N (55)

while the second order condition that the Hessian be positive definite is satisfied for all η's since the Hessian is diagonal and

$$\frac{{\partial }^{2} {J}_{p}}{\partial {η}^{2}} > 0.$$

Now the Lagrange multiplier must satisfy the constraint h′η=b. Defining

$$α ≡ {( \frac{\vert γ \vert}{p} )}^{( \frac{1}{p - 1} )} ,$$

it is possible to show that

$$α = \frac{\vert b \vert}{{‖ h ‖}_{q}^{q}} \qquad ( 56 )$$

equation (56), together with equation (55), yields Resulting in,

$$\begin{matrix}\begin{matrix}{η}_{i} = \vert b \vert \frac{sgn ( {η}_{i} ) {\vert {h}_{i} \vert}^{( \frac{1}{p - 1} )}}{{‖ h ‖}_{q}^{q}} \\ = \vert b \vert \frac{sgn ( γ {h}_{i} ) {\vert {h}_{i} \vert}^{( \frac{1}{p - 1} )}}{{‖ h ‖}_{q}^{q}} \\ = b \frac{sgn ( {h}_{i} ) {\vert {h}_{i} \vert}^{( \frac{1}{p - 1} )}}{{‖ h ‖}_{q}^{q}}\end{matrix} & ( 57 ) \\ \begin{matrix}{‖ η ‖}_{p}^{p} = {\sum }_{i = 1}^{M} {\vert {η}_{i} \vert}^{p} \\ = {\vert b \vert}^{p} \frac{{\sum }_{i = 1}^{M} {\vert {h}_{i} \vert}^{\frac{p}{p - 1}}}{{‖ h ‖}_{q}^{qp}} \\ = {( \frac{\vert b \vert}{{‖ h ‖}_{q}} )}^{p}\end{matrix} & ( 58 )\end{matrix}$$

For p ∈(0,1), note that Jₚ≡∥η∥ₚ^{p} is concave and is to be minimized over the closed convex set

C≡{η|h′η=b}

The set C consists of linear combinations of the following points

$$ϵ = \{ \frac{1}{{h}_{i}} {e}_{i} , i = 1 , … , N \}$$

where eᵢ is the ith element of the canonical basis for R^{N}, meaning the vector whose elements are all zero, except for the ith one. For any point in C, there exists a point in ∈ with smaller p-norm. The search can be limited to ∈. If i*=argmaxᵢ|hᵢ|, then the minimizing point of ∈ is

$${η}^{*} = ( \frac{b}{{h}_{{i}^{*}}} {e}_{{i}^{*}} ) \qquad ( 59 )$$

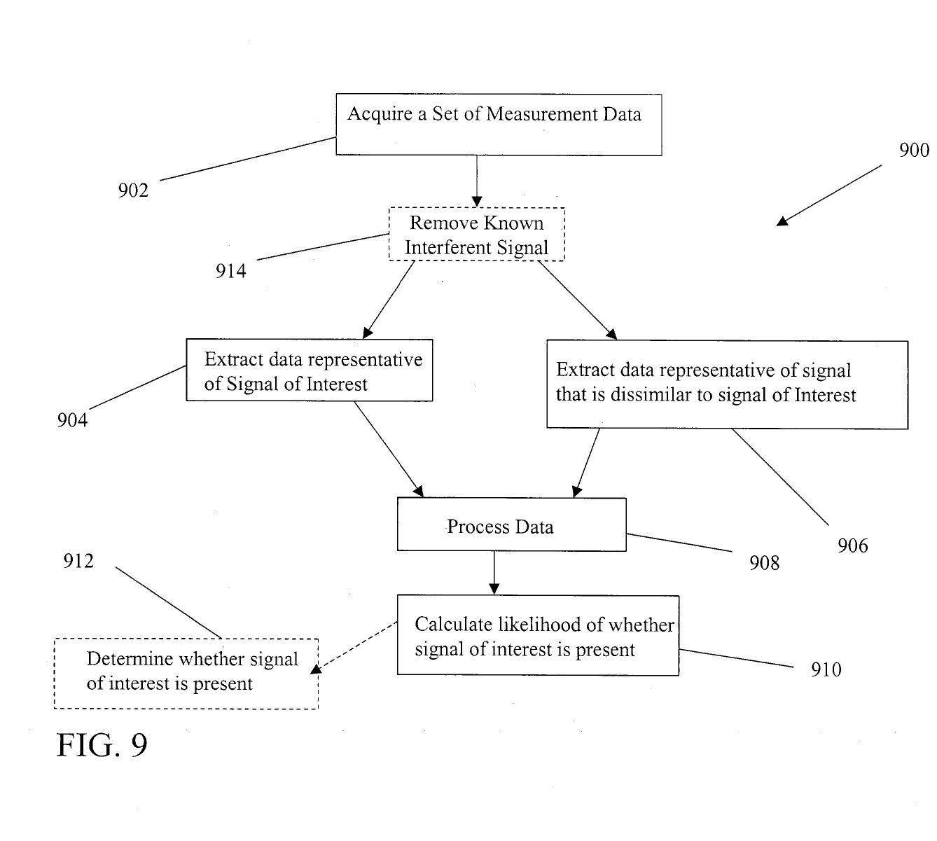

The invention, in another aspect is directed to a method for detecting the presence of a signal of interest in a set of measurement data using, for example, a computer. FIG. 9 is a flowchart 900 depicting a method for detecting the presence of a signal of interest according to an illustrative embodiment of the invention. In this embodiment, the process of the flow chart 900 begins with acquiring 902 a set of measurement data. An optional next step in the process involves removing 914 a known interferent signal from the measurement data. Following the step of removing 914, the process involves extracting 904 data representative of the signal of interest from the resultant of the step of removing 914 and extracting 906 data representative of a signal that is dissimilar to the signal of interest from the step of removing 14. If the optional step of removing is not performed the step of extracting 904 and the step of extracting 906 are instead performed on the resultant of the step of acquiring 902 the measurement data.

The next step in the process involves processing the data that results from the step of extracting 904 and the step of extracting 906. By way of example, the step of processing 908 may involve employing a hypothesis test, such as the hypothesis test described, in part, by equations (2) and (3) describe herein. The next step in the process involves calculating 910 a likelihood of whether the signal of interest is present in the measurement data. By way of example, the step of calculating 910 the likelihood may employ a signal detector, such as the robust matched filter detector described by equation (13). An optional next step in the process may involve determining 912 whether the signal of interest is present in the measurement data based upon the resultant of the step of calculating the likelihood 910.

The method for detecting a signal of interest described herein may be implemented in a particular signal detection application using a variety of electrical hardware and mechanical and electrical components. By way of example, a signal detection system of the invention that implements the aforementioned method for detecting may include a sensor for acquiring measurement data and a computer processor for implementing the hypothesis tests.

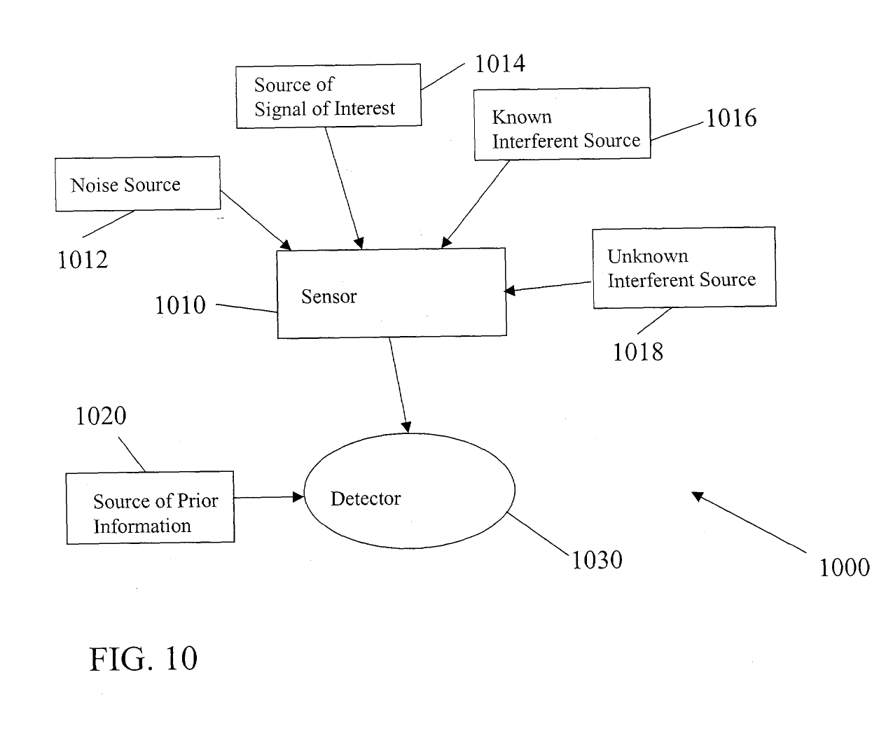

The invention, in another embodiment, as illustrated in FIG. 10, is directed to a system 1000 for detecting the presence of a signal of interest within a set of measurement data. The system 1000 according to the invention has a sensor 1010 that receives signals from a noise source 1012, a signal of interest source 1014, a known interferent source 1016, and an unknown interferent source 1018. The signals, alternatively, may be received by sensor 1010 from a single source or combination of a plurality of sources. The sensor 1010 outputs a set of measurement data that contains the signals received by the sensor 1010 from the noise source 1012, the signal of interest source 1014, the known interferent source 1016, and the unknown interferent source 1018. By way of example, the sensor 1010 may receive from a radar signal source that includes both the signal of interest (e.g., radar signature of a plane approaching a radar antenna) and an unknown interferent (e.g., radar decoy signals intended to obscure a radar signature of the plane).

The signals provided by the noise source 1012 to the sensor 1010 may, for example, be electrical noise that is capable of being mathematically characterized as a Gaussian or generalized Gaussian signal. The signals provided by the known interferent source 1016 that are received by the sensor 1010 may, for example, be radar clutter in the form of radar waves that reflect from irrelevant radar targets.

The system 1000 in this embodiment of the invention has a detector 1030 that receives the set of measurement data from the sensor 1010. The detector 730 determines the presence of a particular signal of interest in the measurement data by implementing a hypothesis test, such as the hypothesis test of equations (2) and (3) described herein. The hypothesis test implemented by the detector 1030 may, for example, use the robust matched filter detector described by λ_{p,rk}(x) of equation (13).

The detector 1030 of the system 1000 in this embodiment of the invention also is capable of using information provided by a source of prior information 1020 to improve the speed and/or accuracy of the detector 1030 in determining the presence of the particular signal of interest in the set of measurement data received by the detector 1030 from the sensor 1010. The prior information may, for example, be data or signals that represent a pattern observed in the set of measurement data that is attributable to the unknown interferent source 1018. The detector 1030 in this embodiment is capable of detecting the presence of the signal of interest faster and/or more accurately because more of the signals received by the sensor 1010 can be determined to be due to, for example, a source other than the plane.

The system 1000 can, alternatively, be used in a functional MRI application to detect which voxel (a contraction for volume element, which is the basic unit of magnetic resonance (MR) reconstruction; represented as a pixel in the display of the MR image) in the brain reacts to a visual stimulus. The system 1000 in this embodiment measures the electrical response of a voxel of the brain in response to a visual stimulus and, the detector 1030 determines through hypothesis testing whether or not the electrical response (set of measurement data) contains a signal representing the response of the brain to the visual stimulus.

Additional applications of the system 1000 include detecting the presence of a specific chemical element or composition within a chemical compound (for example, detecting the presence of toluene in a gas or fluid sample) or detecting whether a part of a flight control system in an aircraft is sending a hardware failure signal to the detector. Other applications include detecting the presence of glucose in blood, the presence of a specific element or compound in a sample tested by a mass spectrometer, or the presence of a specific visual image in data measured by an optical measurement system.

Variations, modifications, and other implementations of what is described herein will occur to those of ordinary skill without departing from the spirit and the scope of the invention. Accordingly, the invention is not to be defined only by the preceding illustrative description.

What is claimed is:

1. A method for determining the presence of a signal of interest within a set of measurement data, the method comprising the steps of:
extracting data representative of a first signal having characteristics associated with the signal of interest from the measurement data;
extracting data representative of one or more second signals having characteristics dissimilar to the signal of interest; and
processing the data representative of the first signal with the data representative of the one or more second signals to determine the likelihood of whether the signal of interest is present in the measurement data.

2. The method of claim 1 further comprising the step of:
filtering the measurement data to remove a known interferent signal from the measurement data.

3. The method of claim 1 further comprising the step of:
determining a probability whether the signal of interest is present within the set of measurement data.

4. The method of claim 1 wherein the one or more second signals comprises a noise signal.

5. The method of claim 4 wherein the noise signal is described at least in part by a non-Gaussian probability density function.

6. The method of claim 5 wherein the non-Gaussian probability density function is a generalized Gaussian probability density function.

7. The method of claim 6 wherein the generalized Gaussian probability density function is a Laplacian probability density function.

8. The method of claim 1 wherein the one or more second signals is described at least in part by a non-Gaussian probability density function.

9. The method of claim 1 wherein the one or more second signals is described at least in part by a generalized Gaussian probability density function.

10. The method of claim 1 wherein the measurement data comprises a known interferent signal.

11. The method of claim 1 wherein the measurement data comprises an unknown interferent signal.

12. The method of claim 1 wherein the step of processing comprises determining whether the signal of interest is present within the measurement data.

13. The method of claim 1 wherein the step of processing comprises:
calculating a ratio of at least two residual values, the ratio representing a likelihood that the signal of interest is present within the measurement data.

14. The method of claim 1 wherein the step of processing comprises:
calculating a ratio of at least two residual values, the ratio representing a likelihood that the signal of interest is absent within the measurement data.

15. The method of claim 1 comprising the step of:
determining the presence of a signal of interest within a set of new measurement data.

16. A system for determining the presence of a signal of interest within a set of measurement data, the system comprising:
a processor for extracting data representative of a first signal having characteristics associated with the signal of interest, extracting data representative of one or more signals having characteristics dissimilar to the signal of interest, and processing the data representative of the first signal with the data representative of the one or more second signals to determine the likelihood of whether the signal of interest is present in the measurement data.

17. The system of claim 16 wherein the processor determines whether the signal of interest is present in the measurement data.

18. The system of claim 16 wherein the processor determines whether the signal of interest is absent in the measurement data.

19. The system of claim 16 comprising:
a sensor for acquiring the measurement data.

20. The system of claim 16 comprising:
a receiver for receiving the measurement data.

21. The system of claim 16 comprising:
a filter for filtering the measurement data to remove a known interferent signal from the measurement data.

22. The system of claim 16 wherein the processor determines a probability of whether the signal of interest is present within the set of measurement data.

23. The system of claim 16 wherein the one or more second signals comprises a noise signal.

24. The system of claim 23 wherein the noise signal is described by a non-Gaussian probability density function.

25. The system of claim 24 wherein the non-Gaussian probability density function is a generalized Gaussian probability density function.

26. The system of claim 25 wherein the generalized Gaussian probability density function is a Laplacian probability density function.

27. The system of claim 16 wherein the one or more second signals is described by a non-Gaussian probability density function.

28. The system of claim 16 wherein the one or more second signals is described by a generalized Gaussian probability density function.

29. A detector for determining the presence of a signal of interest within a set of measurement data, the detector comprising a likelihood ratio of the general form:
$$λ ( x ) = \frac{{x}^{′} ( {P}_{S} - {P}_{U} ) x}{2 {σ}^{2}} ;$$
wherein x is a vector of measurement data;
x′ is a transpose of x;
S is a matrix whose columns span a signal space;
Pₛ is a projection operator that projects a vector along signal space;
U is a matrix whose columns span an interferent space;
Pᵤ is a projection operator that projects a vector along unknown interferent space; and
σ is a standard deviation of noise.

30. A detector for determining the presence of a signal of interest within a set of measurement data, the detector comprising a likelihood ratio of the general form:
$$λ ( x ) = \frac{\vert {s}^{′} x \vert}{{{‖ s ‖}_{q} ‖ x - s {\hat{θ}}_{p} ‖}_{p}} ;$$
wherein x is a vector of measurement data;
\hat{θ}ₚ is a maximum likelihood estimate of θ;
s is a vector that spans a signal space;
θ is a gain vector associated with s;
p is a shape parameter of a probability density function of noise; and
$$q is equal to \frac{p}{p - 1} .$$

31. A detector for determining the presence of a signal of interest within a set of measurement data, the detector comprising a likelihood ratio of the general form:
$$Λ ( x ) = \frac{{‖ x = U {\hat{ψ}}_{p} ‖}_{p}}{{‖ s - S {\hat{θ}}_{p} ‖}_{p}} ;$$
wherein x is a vector of measurement data;
\hat{θ}ₚ is a maximum likelihood estimate of θ;
S is a matrix whose columns span the signal space;
θ is a gain vector associated with S;
U is a matrix whose columns span an interferent space;
\hat{ψ}ₚ is a maximum likelihood estimate of ψ
ψ is a gain vector associated with U; and
p is a shape parameter of a probability density function of noise.

32. A detector for determining the presence of a signal of interest within a set of measurement data, the detector comprising a likelihood ratio of the general form:
$$λ ( x ) = - {( \frac{1}{{ω}_{1}} {‖ x - s {\hat{θ}}_{p} ‖}_{p} )}^{p} + {( \frac{\vert {s}^{′} x \vert}{{‖ {ω}_{0} s ‖}_{q}} )}^{p} ;$$
wherein x is a vector of measurement data;
\hat{θ}ₚ is a maximum likelihood estimate of θ;
s is a vector that spans the signal space;
θ is a gain vector associated with s;
ω₀ is a width factor associated with known noise;
ω₁ is a width factor associated with unknown noise;
p is a shape parameter of a probability density function of noise; and
$$q is equal to \frac{p}{p - 1} .$$

33. A detector for determining the presence of a signal of interest within a set of measurement data, the detector comprising a likelihood ratio of the general form:
$$Λ ( x ) = - {( \frac{1}{{ω}_{1}} {‖ x - s {\hat{θ}}_{p} ‖}_{p} )}^{p} + {( \frac{1}{{ω}_{0}} {‖ x - U {\hat{ψ}}_{p} ‖}_{p} )}^{p} ;$$
wherein x is a vector of measurement data;
\hat{θ}ₚ is a maximum likelihood estimate of θ;
S is a matrix whose columns span the signal space;
θ is a gain vector associated with S;
U is a matrix whose columns span an interferent space;
\hat{ψ}ₚ is a maximum likelihood estimate of ψ
ψ is a gain vector associated with U;
ω₀ is a width factor associated with known noise;
ω₁ is a width factor associated with unknown noise; and
p is a shape parameter of a probability density function of noise.

34. A detector for determining the presence of a signal of interest within a set of measurement data, the detector comprising a likelihood ratio of the general form:
$$Λ ( x ) = \frac{{‖ x ‖}_{p}}{{‖ x - S {\hat{θ}}_{p} ‖}_{p}} ;$$
wherein x is a vector of measurement data;
\hat{θ}ₚ is a maximum likelihood estimate of θ;
S is a matrix whose columns span a signal space;
θ is a gain vector associated with S; and
p is a shape parameter of a probability density function of noise.

35. The detector of claim 34 wherein S is matrix whose columns span a one-dimensional signal space.

36. A detector for determining the presence of a signal of interest within a set of measurement data, the detector comprising a likelihood ratio of the general form:
$$Λ ( x ) = - {( \frac{1}{{ω}_{1}} {‖ x - S {\hat{θ}}_{p} ‖}_{p} )}^{p} + {( \frac{1}{{ω}_{0}} {‖ x ‖}_{p} )}^{p} ;$$
wherein x is a vector of measurement data;
\hat{θ}ₚ is a maximum likelihood estimate of θ;
S is a matrix whose columns span the signal space;
θ is a gain vector associated with S;
ω₀ is a width factor associated with known noise;
ω₁ is a width factor associated with unknown noise; and
p is a shape parameter of a probability density function of noise.

37. The detector of claim 36 wherein S is matrix whose columns span a one-dimensional signal space.
